(19) United States
(12) Patent Application Publication
(10) Pub. No.: US 2010/0250383 A1
(43) Pub. Date: Sep. 30, 2010

(54) STEGANOGRAPHIC MEDIA PAYMENT SYSTEM

(76) Inventors: John D. Frazier, Ramona, CA (US); Michael Reed, San Diego, CA (US); Carol Thomas, Ramona, CA (US)

Correspondence Address: JAMES M. STOVER;TERADATA CORPORATION, 2835 MIAMI VILLAGE DRIVE, MIAMISBURG, OH, 45342, US

(21) Appl. No.: 12/411,719

(22) Filed: Mar. 26, 2009

(51) Int. Cl. G06Q 30/00; G06Q 50/00; G06Q 20/00; G06Q 99/00; G06F 17/30; G06F 15/16

(52) U.S. Cl. 705/26; 709/203; 707/E17.014; 705/310

(57) ABSTRACT

A method for making a digital file available to a user at a client device. The method includes receiving the digital file at the client device, the client device having an associated client identifier, receiving a host identifier at the client device, the host identifier associated with the digital file and receiving a host payment identifier at the client device, the host payment identifier associated with the digital file and the host identifier. A product identifier is obtained from the digital file. A cost associated with the digital file is determined. Payment is obtained corresponding to the determined cost. The digital file is made available to a user at the client device.

### BACKGROUND

On-line media has gained tremendous popularity. Video, audio and still images are readily viewable over Internet networks. One difficulty is that whenever copyrighted material is viewed over a network, the copyright owner is not compensated.

It would be desirable to provide a mechanism to identify the cost of viewing and/or listening to a copyrighted digital file. It would also be desirable to provide a mechanism to extract payment for each use.

### SUMMARY

Described below is a technique for making a digital file available to a user at a client device. The method includes receiving the digital file at the client device, the client device having an associated client identifier, receiving a host identifier at the client device, the host identifier associated with the digital file and receiving a host payment identifier at the client device, the host payment identifier associated with the digital file and the host identifier.

A product identifier is obtained from the digital file. A cost associated with the digital file is determined. Payment is obtained corresponding to the determined cost. The digital file is made available to a user at the client device.

### BRIEF DESCRIPTION OF THE DRAWINGS

FIG. 1 shows a sample system in which a digital file is made available to a user.

FIG. 2 shows a sample database schema

### DETAILED DESCRIPTION

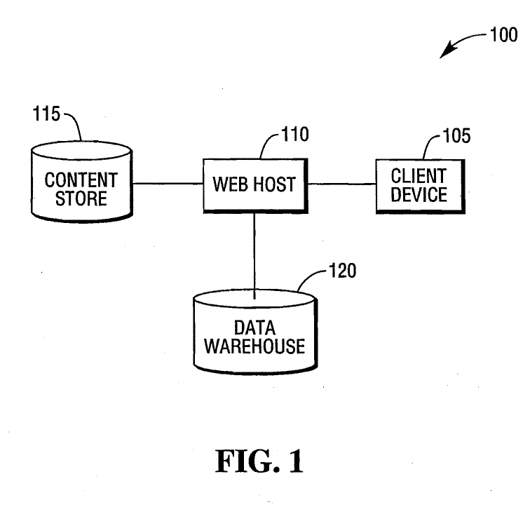

FIG. 1 shows a system 100 in which a digital file is made available to a user. A user operating a client device 105 wishes to have available a digital file. The digital file in one form includes audio and/or video data. A digital file that includes audio and/or video data is made available to the user by playing the digital file on the client device 105. A digital file also includes image data. In this case the digital file is made available to the user by displaying the digital file on the client device.

The client device includes a conventional computer and display device. The client device further includes laptops, MP3 players and mobile enabled computing devices. In each case it is assumed that the client device has an associated client identifier. The identifier uniquely identifies either the client device or a user engaged in a user session on that client device.

The user issues a request for the digital file to a web host 110. The web host is an Internet enabled computing device that is configured to store the digital file on the web host and make the digital file available to the client device 105. It is envisaged that web host 110 is interfaced to a content store 115. The content store 115 is able to store further digital files able to be accessed by web host 110. The web host 110 has an associated host identifier. The host identifier uniquely identifies the host from other hosts available or accessible on the network 100.

A data warehouse 120 stores data relating to the digital file as will be further described below.

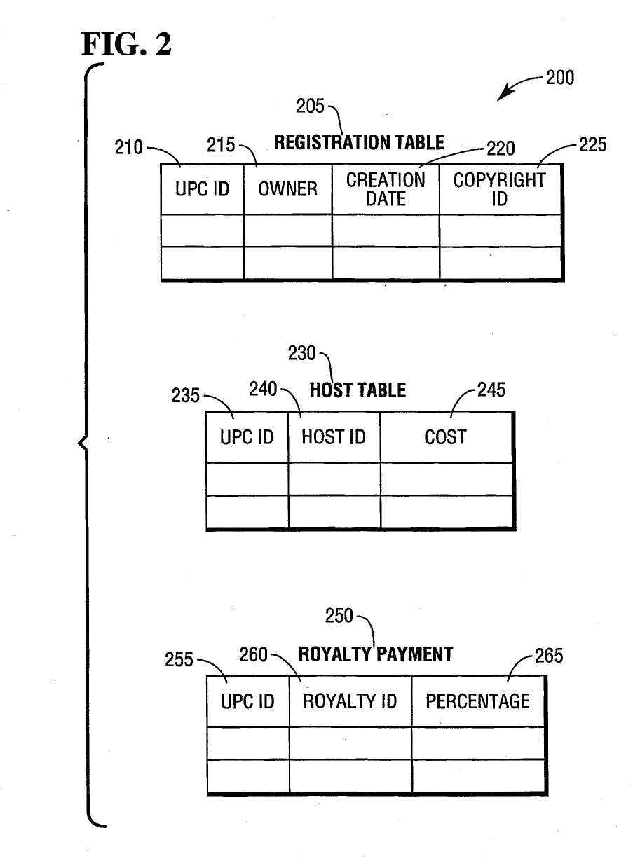

FIG. 2 shows a sample database schema. The schema 200 includes a registration table 205. The registration table associates digital files with related data Each digital file is represented by one row in the registration table 205. A UPC identifier 210 uniquely identifies each digital file. Within the registration table each digital file is associated with an owner 215, a creation date 220 and a copyright identifier 225. The copyright identifier 225 represents a registration number that is allocated where the copyright has been formally registered.

Schema 200 further includes a supplier or host table 230. The host table 230 associates respective digital files with suppliers/hosts and costs. Table 230 for example includes the UPCID field 235, a host identifier field 240 and a cost field 245.

Database schema 200 further includes a royalty payment table 250. The royalty payment table contains several fields. These fields determine how the royalty payment is allocated among more than one copyright owner. The royalty payment table 250 for example includes the UPC ID field 255, a royalty or owner ID field 260 and percentage 265. The UPC ID field values are not necessarily unique within the royalty payment table. Each owner that is entitled to a percentage of royalty for a given digital file has an entry in the royalty payment table 250.

As described above the system determines a cost that is associated with an individual digital file. In the schema shown in 200 the cost is determined by retrieving the cost from the host table 230 using the product identifier code 235 as a key. In one form a query is issued to the host table. The query includes the UPC ID product identifier and the host identifier.

Once payment has been obtained for use of the digital file, the payment is distributed to one or more recipients. Distribution of the payment is determined by retrieving one or more royalty identifiers from the royalty payment table 250. The royalty identifiers are each associated with respective recipients. In the schema 200, retrieving the one or more royalty identifiers involves issuing a query to the royalty payment table 250. The query includes the product identifier 255.

Once payment has been made, the digital file is made available to the user at the client device 105. The payment can be obtained from the user or by some party other than the user.

In one preferred form of the invention the product or UPC identifier is hidden within the digital file with which it is associated. The preferred hidden method involves the use of steganographic encryption. The UPC ID number is embedded within the digital file to identify a copyrighted work The copyrighted digital file includes video, audio and images. When the digital file is created, the steganographic data is inserted throughout the digital file. This ensures that if and/or when a digital file is clipped, the identifier remains within the remaining portion of the copyrighted work. By using steganographic encryption, the work or art remains unaltered to the human eye and ear and undetectable by the end user.

In a preferred embodiment, the client device 105 detects the encrypted UPC identifier within the digital file. Data schema 200 is then used to identify information associated with the UPC identifier as described above. The UPC identifier is associated with one or more owners, creation dates and copyright identifiers. The identifier is also associated with host identifiers and costs as well as royalty sharing identifiers.

The digital file is able to be distributed or copied to multiple locations. The client device 105 that is Internet connected downloads the digital file. The device examines the UPC identifier within the digital file. The data warehouse 120 gives access to identify payment details. It is envisaged that payment can be made in two forms. One is payment made by an advertiser and another is payment made by an individual.

In one embodiment the host pays whenever a user views a copyrighted digital file. In these circumstances a user does not make payment. Instead the user accesses the digital file from an advertising based hosting site. The website accesses the data warehouse 120 and indicates that the host site will pay for the viewing of the file.

Another embodiment involves an individual payment method. This occurs when a digital file is copied from a host site and viewed from a different location. In this case the payer information about the download site does not match. The user has the option of paying directly to view the media The player would have the user's payment information and contact the payment database to pay using the user's information.

From time to time it is envisaged that copyright information will change such as owner or copyright identifier. Furthermore, royalty percentages could also change. It is a simple matter to update the database such as schema 200. The digital file itself is not affected and retains its original UPC ID code.

Steganography takes one piece of information and hides it within another. Digital files contain unused or insignificant areas of data Steganography takes advantage of the unused areas in video, audio and image files and replaces them with information. Steganography can also be used to place hidden steganographic data throughout video, audio and image files.

There are many algorithms to embed or to hide data into images. Most common approaches to hiding information in digital images are masking and filtering, algorithms and transformations, and least significant bit insertion.

The steganographic algorithm described below involves two secret keys. The key K serves for message encryption to insure illegibility of message m in case the steganographic key is compromised (and the algorithm is known), the key L secures undetectability of embedding in the cover media.

STEGO(m, I, K, L)= EMBED(ENCRYPT(m, K), I, L)
m: message to embed in image
I: unaltered image
K: Key used to encrypt message m
L: Key used to embed encrypted message into image
If the K key is null, the message is not encrypted.

A user defined type is preferably used to manipulate a steganographic image within a database.

The following is the SQL required to create the steganograph type and its methods.

Create structured type Steno_Image (

| | |
|---|---|
| IMAGE BLOB, | /* Image data, may contain text */ |
| ENCRYPTED BOOLEAN, | /* Indicator if image is expected to |
| | have text */ |
| SECRET_MESSAGE CLOB, | /* Text to be embedded or was |
| | embedded */ |
| INTEGER L_KEY, | /* Image embedding key */ |
| INTEGER K_KEY, | /* Text encrypting key */ |

```
);
    CREATE OPAQUE TYPE STENOGRAPH
        LIBRARY ‘S!C:\opaque_lib\steno.lib’
        /* Permit data elements to be populated. */
        /* STENO=TRUE for image w/text, STENO=FALSE for
        image w/out text. */
        CONSTRUCTOR METHOD steno_image(IMAGE BLOB,
        STENO BOOLEAN)
        RETURNS NULL
        SPECIFIC create_image
        LANGUAGE C
        NO SQL,
  /* Place text in the data element using keys. */
  /* if K_KEY is NULL text is not encrypted. */
    METHOD embed_text(TEXT CLOB, L_KEY INTEGER,
    K_KEY INTEGER)
        RETURNS CLOB
        LANGUAGE C
        PARAMETER STYLE SQL
        DETERMINISTIC
        NO SQL
  /* Retrieve text from element using keys. */
    METHOD retrieve_text(L_KEY INTEGER, K_KEY INTEGER)
        RETURNS CLOB
        LANGUAGE C
        PARAMETER STYLE SQL
        DETERMINISTIC
        NO SQL
  /* Return image with embedded text. */
  METHOD embedded_image( )
        RETURNS BLOB
        LANGUAGE C
        PARAMETER STYLE SQL
        DETERMINISTIC
      NO SQL
  /* Return untouched original image. */
  METHOD cover_image( )
        RETURNS BLOB
        LANGUAGE C
        PARAMETER STYLE SQL
        DETERMINISTIC
      NO SQL
    /* Generate key using some method. */
    METHOD generate_key( )
        RETURNS INTEGER
        LANGUAGE C
        PARAMETER STYLE SQL
        DETERMINISTIC
        NO SQL
```

There are two alternative techniques to create images in the database. Either the image being stored is a cover image which is used to hide data or it is a steganographic image and contains embedded data.

The constructor method described above is used to store the image data and the STENO flag indicates if it contains embedded steganographic data.

The following SQL statements are used to create a table and store images using the constructor method.

CREATE TABLE STENO1(ID INTEGER, KEY INTEGER,
IMAGE STENO_IMAGE);
USING (ID INTEGER, B BLOB)
INSERT INTO STENO1(:ID, new STENO_IMAGE(:IMAGE,TRUE));

There are two basic operations that are supported. They are inverses of each other.

The first basic operation is the addition of text to be encrypted/hidden and the generation of the steganographic image from the cover image. Text can be added using the embed_text( ) method. A key is returned for use in decrypting the image.

```
USING (ID INTEGER, T CLOB)
BEGIN REQUEST
    UPDATE SET L_KEY=IMAGE.generate_key( ) FROM STENO1
    WHERE ID=:ID;
    UPDATE SET K_KEY=IMAGE.generate_key( ) FROM STENO1
    WHERE ID=:ID;
    UPDATE SET IMAGE=IMAGE.embed_text(:T,L_KEY, K_KEY)
    FROM STENO1 WHERE
ID=:ID;
END REQUEST;
```

The second basic operation involves returning hidden and possibly encrypted text from a steganographic image.

USING (ID INTEGER, L_KEY INTEGER, K_KEY INTEGER)
SELECT IMAGE.retrieve_text(:L_KEY, :K_KEY) FROM
STENO1 WHERE ID=:ID;

The table image data can be retrieved as original images or those with watermarks using the following view:

```
CREATE VIEW protected AS SEL ID,
    sel id, case user when ‘Administrator’ UT1 then
IMAGE.COVER_IMAGE( )
        else IMAGE.EMBED_IMAGE( ) end “Image” FROM
        STENO1;
```

The text above describes one or more specific embodiments of a broader invention. The invention also is carried out in a variety of alternative embodiments and thus is not limited to those described here. Those other embodiments are also within the scope of the following claims.

We claim:

1. A method for making a digital file available to a user at a client device, the method comprising:
receiving the digital file at the client device, the client device having an associated client identifier,
receiving a host identifier at the client device, the host identifier associated with the digital file;
receiving a host payment identifier at the client device, the host payment identifier associated with the digital file and the host identifier;
obtaining a product identifier from the digital file;
determining a cost associated with the digital file;
obtaining payment corresponding to the determined cost; and
making the digital file available to a user at the client device.

2. The method of claim 1 wherein determining the cost associated with the digital file further comprises retrieving the cost from a host table.

3. The method of claim 2 wherein retrieving the cost from the host table comprises issuing a query to the host table, the query including the product identifier and the host identifier.

4. The method of claim 1 further comprising distributing the obtained payment to one or more recipients.

5. The method of claim 4 further comprising determining the one or more recipients by retrieving one or more royalty identifiers from a royalty payment table, the one or more royalty identifiers associated with respective recipients.

6. The method of claim 5 wherein retrieving the one or more royalty identifiers comprises issuing a query to the royalty payment table, the query including the product identifier.

7. The method of claim 1 wherein the client device is connected to a data network, the digital file received over the data network.

8. The method of claim 1 wherein the client device is provided with a data port, the digital file received through the data port.

9. The method of claim 1 wherein the client identifier is stored in a computer readable medium associated with the client device.

10. The method of claim 1 wherein the client identifier is associated with the client device during a user session involving the client device.

11. The method of claim 1 wherein the digital file is made available to a user at the client device only on obtaining the payment corresponding to the determined cost.

12. The method of claim 11 wherein payment is obtained from the user.

13. The method of claim 11 wherein payment is obtained from a party other than the user.

14. The method of claim 1 wherein the digital file includes audio or video data, and wherein the digital file is made available to the user by playing the digital file on the client device.

15. The method of claim 1 wherein the digital file includes image data, and wherein the digital file is made available to the user by displaying the digital file on the client device.

16. The method of claim 1 wherein the product identifier is embedded within the digital file.

17. The method of claim 16 wherein two or more copies of the product identifier are embedded within the digital file.

18. The method of claim 17 wherein the two or more copies of the product identifier are encrypted.

19. The method of claim 16 further comprising the client device detecting the product identifier within the digital file.

20. A computer program stored on tangible storage media comprising executable instructions for performing a method for making a digital file available to a user at a client device, the method comprising:
receiving the digital file at the client device, the client device having an associated client identifier;
receiving a host identifier at the client device, the host identifier associated with the digital file;
receiving a host payment identifier at the client device, the host payment identifier associated with the digital file and the host identifier;
obtaining a product identifier from the digital file;
determining a cost associated with the digital file;
obtaining payment corresponding to the determined cost; and
making the digital file available to a user at the client device.

21. A system for making a digital file available to a user at a client device, the system configured to:
receive the digital file at the client device, the client device having an associated client identifier;
receive a host identifier at the client device, the host identifier associated with the digital file;
receive a host payment identifier at the client device, the host payment identifier associated with the digital file and the host identifier;
obtain a product identifier from the digital file;
determine a cost associated with the digital file;
obtain payment corresponding to the determined cost; and
make the digital file available to a user at the client device.
